(19) United States
(12) Patent Application Publication
(10) Pub. No.: US 2015/0129519 A1
(43) Pub. Date: May 14, 2015

(54) HOLDING RACK FOR DIFFERENT TYPES OF FOOD SERVING PRODUCTS

(71) Applicant: Fred Allan Hudson, South Charleston, WV (US)

(72) Inventor: Fred Allan Hudson, South Charleston, WV (US)

(21) Appl. No.: 14/537,983

(22) Filed: Nov. 11, 2014

Related U.S. Application Data
(60) Provisional application No. 61/903,917, filed on Nov. 13, 2013.

(51) Int. Cl. A47B 81/04; A47B 47/00; A47J 47/16

(52) U.S. Cl. CPC A47B 81/04; A47J 47/16; A47B 47/0075
USPC 211/41.2

(57) ABSTRACT

A holding rack allows a cook to remove scoops or Spoodles without searching through a drawer. The holding rack provides quick and easy access to allow the cook to get to the appropriate size scoop or Spoodle by allowing the items to be easily visualized and grasped without having to move other items about. The holding rack prevents contamination and time consumption that can occur when rummaging through a drawer for a desired utensil.

### CROSS-REFERENCE TO RELATED APPLICATIONS

This application claims the benefit of priority of U.S. provisional application No. 61/903,917, filed Nov. 13, 2013, the contents of which are herein incorporated by reference.

### BACKGROUND OF THE INVENTION

The present invention relates to holding racks and, more particularly, to a metal holding rack for holding two different types of food serving scoops or spoodles.

Utensils are often stored in a drawer. When a utensil is needed, the cook must look through the drawer and touch items therein with their hands to get to the appropriate utensil. This can cause cross-contamination, can cause organization issues and can slow down work in a kitchen. Moreover, many local health departments disapprove of the storage of utensils in a drawer due to cross-contamination issues.

This can be especially true when looking for a scoop of a particular size. The cook must look over and handle unorganized utensils to find the appropriate scoop. Similar issues may arise when looking for various spoons utensils, such as Spoodles.

As can be seen, there is a need for holding rack that can hold various types of utensils and allow quick and easy access thereto.

### SUMMARY OF THE INVENTION

In one aspect of the present invention, a holding rack for cooking utensils comprises a backsplash formed as a plate member; a plurality of fingers extending from a bottom edge of the backsplash; a plurality of slots disposed between the fingers, the plurality of slots receiving a plurality of scoops therein, wherein the scoops, when disposed in the plurality of slots, do not touch each other; and a bend in a tip of each of the fingers.

In another aspect of the present invention, a method for storing scoops to prevent cross-contamination between the scoops comprises placing a first scoop of a first size in a first slot, of a plurality of slots, formed between two fingers of a plurality of fingers extending from a bottom edge of a backsplash formed as a plate member; placing a second scoop of a second size in a second slot, the first scoop being prevented from contacting the second scoop when the first and second scoops are disposed in their respective first and second slots; and preventing the first and second scoops from sliding out of the first and second slots by bending a tip of each of the plurality of fingers.

### BRIEF DESCRIPTION OF THE DRAWINGS

FIG. 1 is a perspective view of a holding rack according to an exemplary embodiment of the present invention;

FIG. 2 is a perspective view of a hold rack according to an alternate embodiment of the present invention;

FIG. 3 is a front view of a scoop holder designed for three rows of scoops, according to an exemplary embodiment of the present invention; and

FIG. 4 is a front view of a scoop holder designed for five rows of scoops, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a holding rack that allows a cook to remove scoops or Spoodles without searching through a drawer. The holding rack provides quick and easy access to allow the cook to get to the appropriate size scoop or Spoodle by allowing the items to be easily visualized and grasped without having to move other items about.

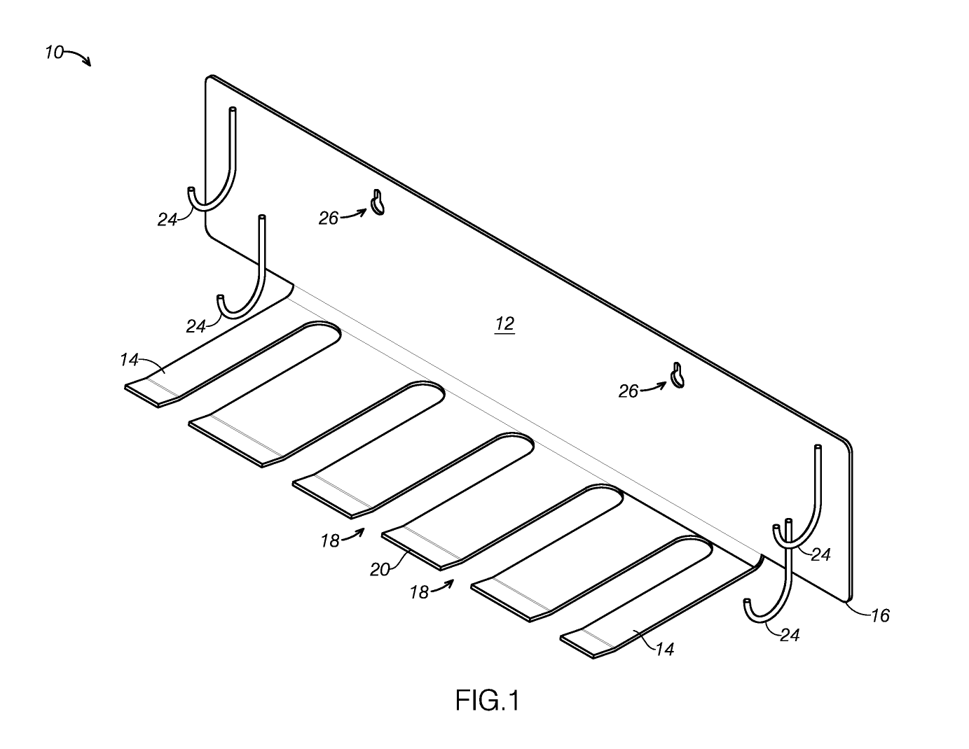

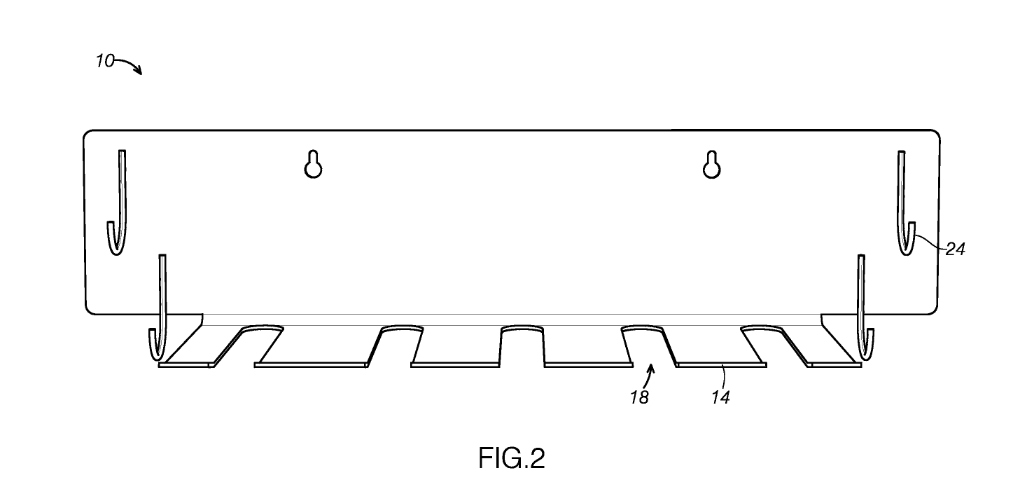

Referring now to FIGS. 1 through 4, the holding rack 10 can have a backsplash member 12 with a plurality of fingers 14 extending from a bottom edge 16 thereof. The fingers 14 can be spaced apart to form a plurality of slots 18. The fingers 14 can include a bend 20 on the tips 22 thereof, where the bend 20 can be sufficient to urge any utensils, such as scoops 22, disposed in the slots 18 from sliding out of the slots 18. The fingers 14 can form slots 18 that have various spaces therebetween. For example, end slots can have a spacing of about 1⅛ inch, a center slot can have a spacing of about 2⅛ inches and slots between the end and center slot can have a spacing of about 2½ inches. Of course, the slot spacing can vary within the scope of the present invention. Typically, the slots 18 are spaced so that bowls of various sized scoops 22 disposed in the slots 18 do not touch.

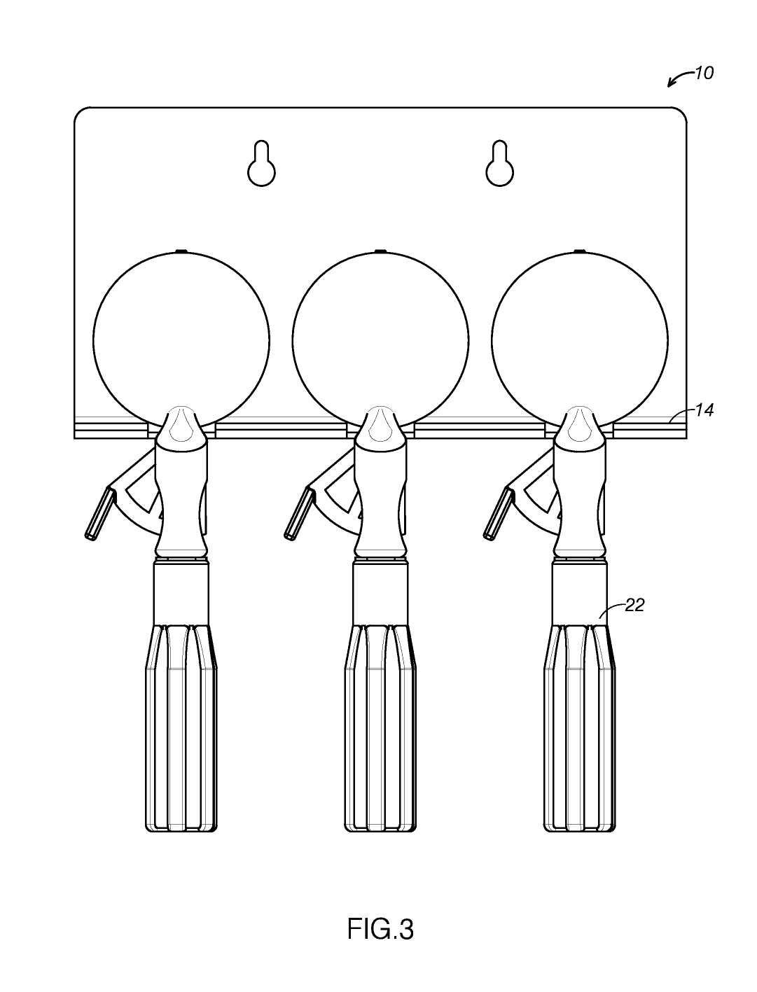

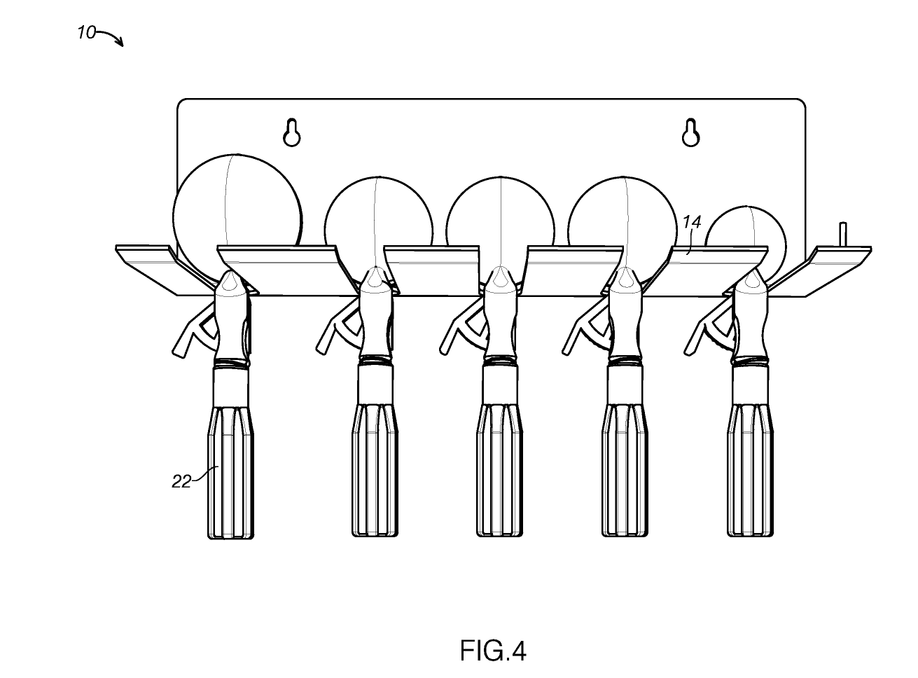

The fingers 14 forming the slots 18 can extend from the bottom 16 of the backsplash member 12, leaving a space on each end that does not have any fingers 14. This space can be from about 2 to about 4 inches, typically about 3 inches. Hooks 24 can be disposed on each end where this space is present. Typically two hooks 24 are disposed on each end. In some embodiments, as shown in FIG. 1, the hooks 24 can be offset in height, thereby not permitting bowls of Spoodles hung on each of the hooks to touch. In other embodiments, the hooks 24 may be disposed at the same height, which may be useful for Spoodles having different length handles. The hooks 24 may not be present, as shown in FIGS. 3 and 4, resulting in a holding rack designed exclusively for various sizes of scoops. The hooks 24 may be sized to hold one or more spoon utensils, such as Spoodles.

The holding rack 10 can be made from various materials, typically stainless steel, such as 18 gauge stainless steel. The slots 18 can be laser cut, for example, or formed by other conventional processes. The number of slots 18 and the length of the holding rack 10 can vary with application. In FIG. 1, there is shown a holding rack 10 having five slots 18 and four hooks 24, formed about 22 inches long. Mounting holes 26 can be cut in the backsplash member 12 to permit easy mounting on a surface. The design of FIG. 1 can, for example, hold up to 20 scoops and 12 spoodles. The design of FIG. 3 may hold 6 scoops, while the design of FIG. 4 may hold from 20 to 40 scoops, depending on the length of the fingers.

While the Figures show the slots cut along the same plane, in some embodiments, the slots can have varying heights (similar to the varying heights of the hooks in the embodiment of FIG. 1) to further assist in keeping the bowls of the scoops from touching.

It should be understood, of course, that the foregoing relates to exemplary embodiments of the invention and that modifications may be made without departing from the spirit and scope of the invention as set forth in the following claims.

What is claimed is:

1. A holding rack for cooking utensils, comprising:
a backsplash formed as a plate member;
a plurality of fingers extending from a bottom edge of the backsplash;
a plurality of slots disposed between the fingers, the plurality of slots receiving a plurality of scoops therein, wherein the scoops, when disposed in the plurality of slots, do not touch each other; and
a bend in a tip of each of the fingers.

2. The holding rack of claim 1, wherein the plurality of slots include at least three slots.

3. The holding rack of claim 1, wherein at least two of the plurality of fingers are of different sizes.

4. The holding rack of claim 1, further comprising at least two hooks disposed at opposite sides of the backsplash.

5. The holding rack of claim 4, wherein the at least two hooks include two hooks on each of the opposite sides of the backsplash.

6. The holding rack of claim 5, wherein the at least two hooks are disposed at offset heights on the backsplash.

7. The holding rack of claim 1, further comprising mounting holes formed through the backsplash.

8. A method for storing scoops to prevent cross-contamination between the scoops, comprising:
placing a first scoop of a first size in a first slot, of a plurality of slots, formed between two fingers of a plurality of fingers extending from a bottom edge of a backsplash formed as a plate member;
placing a second scoop of a second size in a second slot, the first scoop being prevented from contacting the second scoop when the first and second scoops are disposed in their respective first and second slots; and
preventing the first and second scoops from sliding out of the first and second slots by bending a tip of each of the plurality of fingers.

9. The method of claim 8, further comprising placing additional scoops in the first and second slots, where the additional scoops in the first slot do not contact the additional scoops in the second slot.

10. The method of claim 8, wherein the plurality of slots include at least three slots.

11. The method of claim 8, wherein at least two of the plurality of fingers are of different sizes.

12. The method of claim 8, further comprising hanging one or more scoop utensils on at least two hooks disposed at opposite sides of the backsplash.

14. The method of claim 12, wherein the at least two hooks include two hooks on each of the opposite sides of the backsplash.

15. The method of claim 14, wherein the at least two hooks are disposed at offset heights on the backsplash.

16. The method of claim 8, further comprising mounting the backsplash to a surface by hanging the backsplash on mounting holes formed therethrough.
